(19) United States
(12) Patent Application Publication
(10) Pub. No.: US 2010/0071618 A1
(43) Pub. Date: Mar. 25, 2010

(54) FILM COATING HOLDER AND FILM COATING DEVICE USING SAME

(75) Inventor: CHIEN-HAO HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/494,277

(22) Filed: Jun. 30, 2009

(30) Foreign Application Priority Data
Sep. 25, 2008 (CN) 200810304671.1

(51) Int. Cl. B05C 13/00

(52) U.S. Cl. 118/500

(57) ABSTRACT

A film coating device for coating a flexible substrate includes a housing and a film coating holder for holding the flexible substrate. The housing defines a chamber, and the film coating holder is received in the chamber. The film coating holder includes a motor, a driving roller, and a driven roller. The driving roller is rotatable by a motor relative to the housing. The driven roller is substantially parallel to the driving roller. The driven roller is rotatable together with the driving roller by transmission of the flexible substrate.

### BACKGROUND

1. Technical Field

The present disclosure relates to film coating devices and, particularly, to a film coating holder and a film coating device for coating a flexible substrate.

2. Description of Related Art

In a typical film coating process for a flexible substrate, the flexible substrate is usually attached to a film coating holder with one surface of the flexible substrate facing a target material. However, in some film coating methods, such as sputter-coating etc., the temperature of the flexible substrate increases during film coating. As a result, the flexible substrate is usually deformed, such as warped, and cause the film coated on the flexible substrate non-uniform.

What is needed, therefore, is a film coating holder and a film coating device to overcome or at least mitigate the above-described problem.

### BRIEF DESCRIPTION OF THE DRAWINGS

Many aspects of the present film coating holder and film coating device can be better understood with reference to the accompanying drawings. The components in the drawings are not necessarily drawn to scale, the emphasis instead being placed upon clearly illustrating the principles of the present film coating holder and film coating device. In the drawings, all the views are schematic.

FIG. 1 is a cross-sectional view of a film coating device according to an exemplary embodiment.

FIG. 2 is a cross sectional view of the film coating device taken along line II-II of FIG. 1.

### DETAILED DESCRIPTION

Embodiments of the present disclosure will now be described in detail below, with reference to the accompanying drawings.

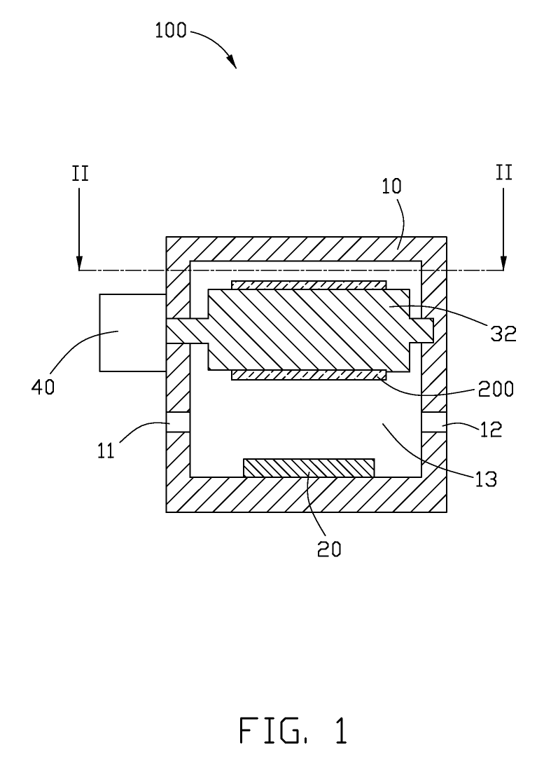

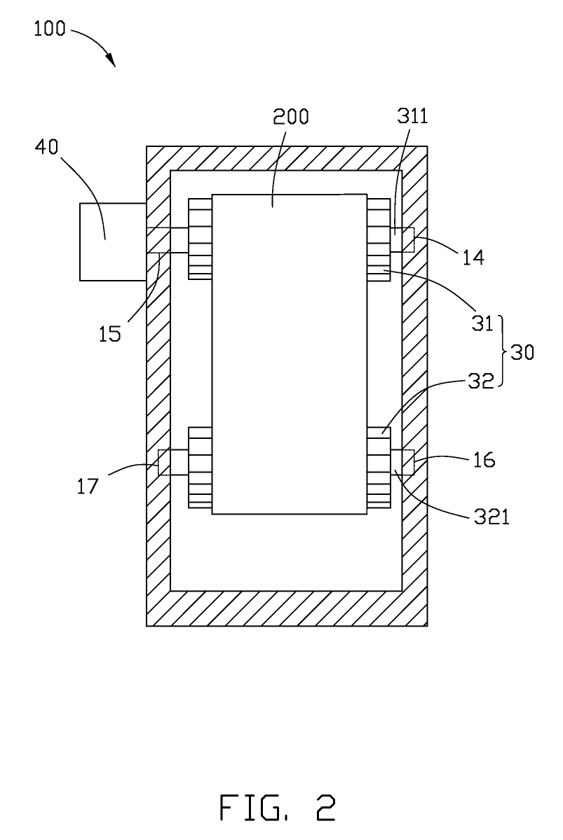

Referring to the FIG. 1 and FIG. 2, a film coating device 100 for coating a flexible substrate 200, according to an exemplary embodiment, is shown. The film coating device 100 includes a housing 10, a target material 20, a film coating holder 30, and a motor 40.

The housing 10 defines a chamber 13 therein. The target material 20 and the film coating holder 30 are received in the chamber 13. The housing 10 defines a gas inlet 11 and a gas outlet 12 in the sidewall thereof. The gas inlet 11 and the gas outlet 12 communicate with the chamber 13. The gas outlet 12 can be connected to a vacuum pump (not shown) for vacuumizing the chamber 13. The gas inlet 11 is configured for introducing an inert gas, such as an argon gas, or a krypton gas into the housing 10.

The film coating holder 30 includes a driving roller 31 and a driven roller 32. The driving roller 31 and the driven roller 32 are elongated, such as, prisms and cylinders. The driving roller 31 is substantially parallel to the driven roller 32.

The driving roller 31 is rotatable about a first rotation shaft 311. Corresponding to the first rotation shaft 311, the housing 10 defines a first receiving hole 14 and a through hole 15. One end of the first rotation shaft 311 is received in the first receiving hole 14, and the other end of the first rotation shaft 311 is connected to the motor 40 via the through hole 15. In the present embodiment, the first rotation shaft 311 is integrally formed with driving roller 31.

The driven roller 32 is rotatable about a second rotation shaft 321. Corresponding to the second rotation shaft 321, the housing 10 defines a second receiving hole 16 and a third receiving hole 17. Two ends of the second rotation shaft 321 are received in the second receiving hole 16 and the third receiving hole 17, respectively. In the present embodiment, the second rotation shaft 321 is integrally formed with driven roller 32.

In the present embodiment, the film coating holder 30 is supported by the housing 10. It is understood that, the film coating holder 30 can also be supported by a bracket received in the housing 10.

In the present embodiment, the motor 40 is fixed to the outer surface of the housing 10. In other embodiments, the motor 40 can also be received in the housing 10.

When using the film coating device 100 to coat films on the flexible substrate 200, the flexible substrate 200 need be looped around the driving roller 31 and the driven roller 32 first, and then the two ends of the flexible substrate 200 need be connected. Thus, the flexible substrate 200 can be used as a transmission strap, and the driven roller 32 can rotate together with the driving roller 31 by the transmission of the flexible substrate 200. Because the flexible substrate 200 is used as a transmission strap, there will be a tensile force applied to the flexible substrate 200 when the driving roller 31 rotates. The tensile force applied to the flexible substrate 200 can mitigate the deformation of the flexible substrate 200 during film coating.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A film coating device for coating a flexible substrate comprising:
a housing defining a chamber therein; and
a film coating holder for holding the flexible substrate, the film coating holder being received in the chamber and comprising:
a motor;
a driving roller being driven by the motor and rotatable relative to the housing; and
a driven roller substantially parallel to the driving roller, such that the flexible substrate can be looped around the driving roller and the driven roller, the driven roller configured for being driven by the driving roller and jointly rotatable with the driving roller by transmission of the flexible substrate.

2. The film coating device of claim 1, wherein the housing defines a gas inlet in a sidewall thereof, and the gas inlet is communicated with the chamber.

3. The film coating device of claim 1, wherein the housing defines a gas outlet in a sidewall thereof, and the gas outlet is communicated with the chamber.

4. The film coating device of claim 3, further comprising a vacuum pump connected to the gas outlet for vacuumizing the chamber.

5. The film coating device of claim 1, wherein the driving roller and the driven roller are elongated.

6. The film coating device of claim 5, wherein the driving roller and the driven roller are prisms.

7. The film coating device of claim 5, wherein the driving roller and the driven roller are cylinders.

8. The film coating device of claim 1, further comprising a first rotation shaft, wherein the driving roller is rotatable about the first rotation shaft, the housing defines a first receiving hole and a through hole, one end of the first rotation shaft is received in the first receiving hole, and the other end of the first rotation shaft extends through the through hole and is connected to the motor.

9. The film coating device of claim 8, wherein the first rotation shaft is integrally formed with the driving roller.

10. The film coating device of claim 1, further comprising a second rotation shaft, wherein the driven roller is rotatable about the second rotation shaft, the housing defines a second receiving hole and a third receiving hole, two ends of the second rotation shaft are received in the second receiving hole and the third receiving hole, respectively.

11. The film coating device of claim 10, wherein the second rotation shaft is integrally formed with the driven roller.

12. The film coating device of claim 1, wherein the motor is fixed to the outer surface of the housing.

13. A film coating holder for holding a flexible substrate comprising:
a driving roller rotatable by a motor; and
a driven roller substantially parallel to the driving roller, such that the flexible substrate can be looped around the driving roller and the driven roller, the driven roller being rotatable together with the driving roller by transmission of the flexible substrate.

14. The film coating holder of claim 13, wherein the driving roller and the driven roller are elongated.

15. The film coating holder of claim 14, wherein the driving roller and the driven roller are prisms.

16. The film coating holder of claim 14, wherein the driving roller and the driven roller are cylinders.

17. The film coating holder of claim 13, further comprising a first rotation shaft, wherein the driving roller is rotatable about the first rotation shaft, the first rotation shaft is integrally formed with the driving roller.

18. The film coating holder of claim 13, further comprising a second rotation shaft, wherein driven roller is rotatable about the second rotation shaft, and the second rotation shaft is integrally formed with the driven roller.
